(19) United States
(12) Patent Application Publication
(10) Pub. No.: US 2025/0361851 A1
(43) Pub. Date: Nov. 27, 2025

(54) PYRAMID WIND TURBINE

(71) Applicants: Cevdet KOSE, Antalya (TR); Hayrettin GUMUSKAYA, Istanbul (TR)

(72) Inventors: Cevdet KOSE, Antalya (TR); Hayrettin GUMUSKAYA, Istanbul (TR)

(21) Appl. No.: 18/873,769

(22) PCT Filed: Jun. 1, 2023
(86) PCT No.: PCT/TR2023/050501

§ 371 Date: Dec. 11, 2024

(30) Foreign Application Priority Data
Jun. 26, 2022 (TR) 2022/010571

(51) Int. Cl. F03D 3/00; F03D 3/02

(52) U.S. Cl. CPC F03D 3/005; F03D 3/02; F05B 2240/40

(57) ABSTRACT

A pyramid wind turbine is provided, which is composed of turbines of different sizes and dimensions shaped as a circle, which overlap in a vertical structure and expand as they go down and rotate either dependently or independently from each other on the horizontal axis to the ground. Turbine is generating device that allows generate of high amounts of energy using limited area, adapts to the environment with its visual design. The turbine is a masterpiece of industrial design. The device has a stabilising and bearing platform, wind turbines expanding from top to bottom as a pyramid on this platform, the upper and lower apparatus of the turbine that co-ordinates these turbines with each other, fixes and carries the blades and transfers the power generated to the alternator.

### CROSS REFERENCE TO THE RELATED APPLICATIONS

This application is the national phase entry of International Application No. PCT/TR2023/050501, filed on Jun. 1, 2023, which is based upon and claims priority to Turkish Patent Application No. 2022/010571, filed on Jun. 26, 2022, the entire contents of which are incorporated herein by reference.

### TECHNICAL FIELD

The present invention relates to a wind turbine composed of turbines of different sizes and dimensions shaped as a circle, which overlap in a vertical (vertical) structure and expand as they go down and rotate either dependently or independently from each other on the horizontal (horizontal) axis to the ground.

### BACKGROUND

Today, many devices and turbines generate electricity using wind power. These turbines are manufactured and used in different sizes and with different materials and techniques based on their production capacity. However, the existing turbines are used by erecting only one on a single platform. This kind of use brings the following deficiencies and problems.
a) When only one turbine can be used on a single platform or in an installation site, the costs excessively rise,
b) Since each product uses a separate space, this causes considerable losses of floor space,
c) It is not possible to turn the power losses or idle powers in the products that are used separately into yields by combining them.

These deficiencies outlined above make it difficult and inefficient to generate electricity from wind energy.

### SUMMARY

The turbines and blades used in our invention can be produced from materials made of all kinds of wood, metal, plastic, fabric, and textile chemicals, can shape turbines of different sizes and dimensions as a single structure on a platform, and eliminate all the above-mentioned deficiencies and problems due to the features that each turbine can operate independently or in connection with each other and transmit all the power it generates to the same point. Due to the developed automatic transmission system, which continues to rotate and generate power even at the lowest wind speed and operates to produce the highest efficiency based on the condition of the blowing wind at different speeds, the possibility of high energy production has been achieved at low costs and in very narrow areas.

As a visual design, it offers a visual appearance harmonious with nature. Painted in green, it offered the opportunity to grow turbine forests.

### BRIEF DESCRIPTION OF THE DRAWINGS

FIG. 1—Opposite view of the pyramid wind turbine (P/1)

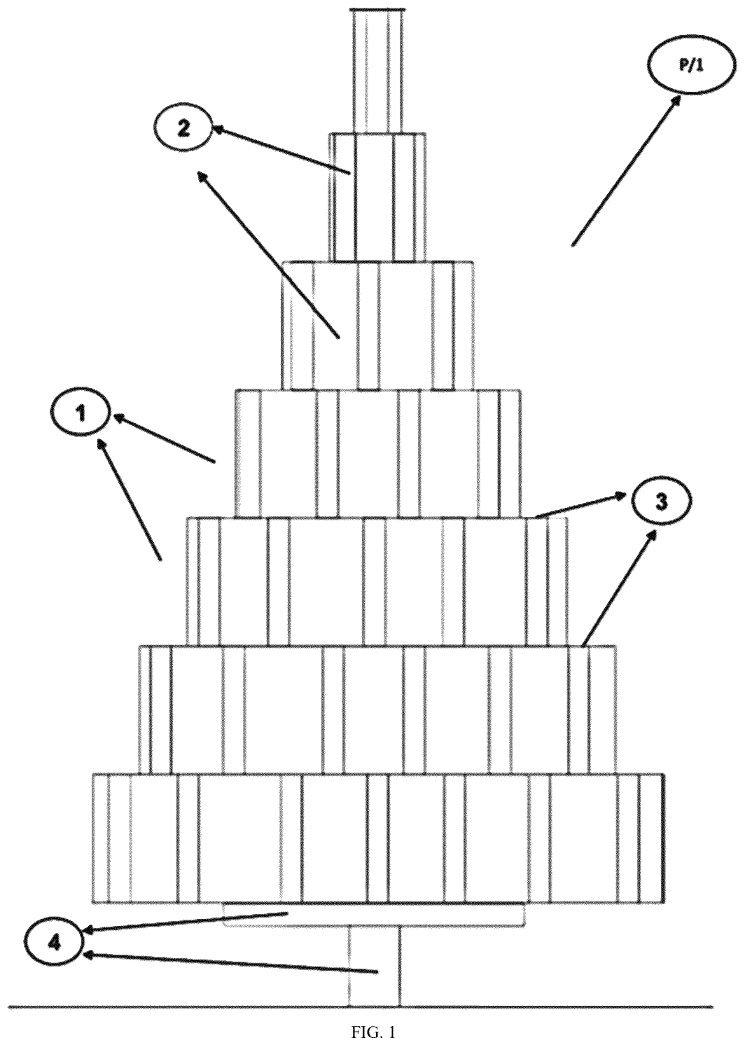

FIG. 2—Top view of the pyramid wind turbine

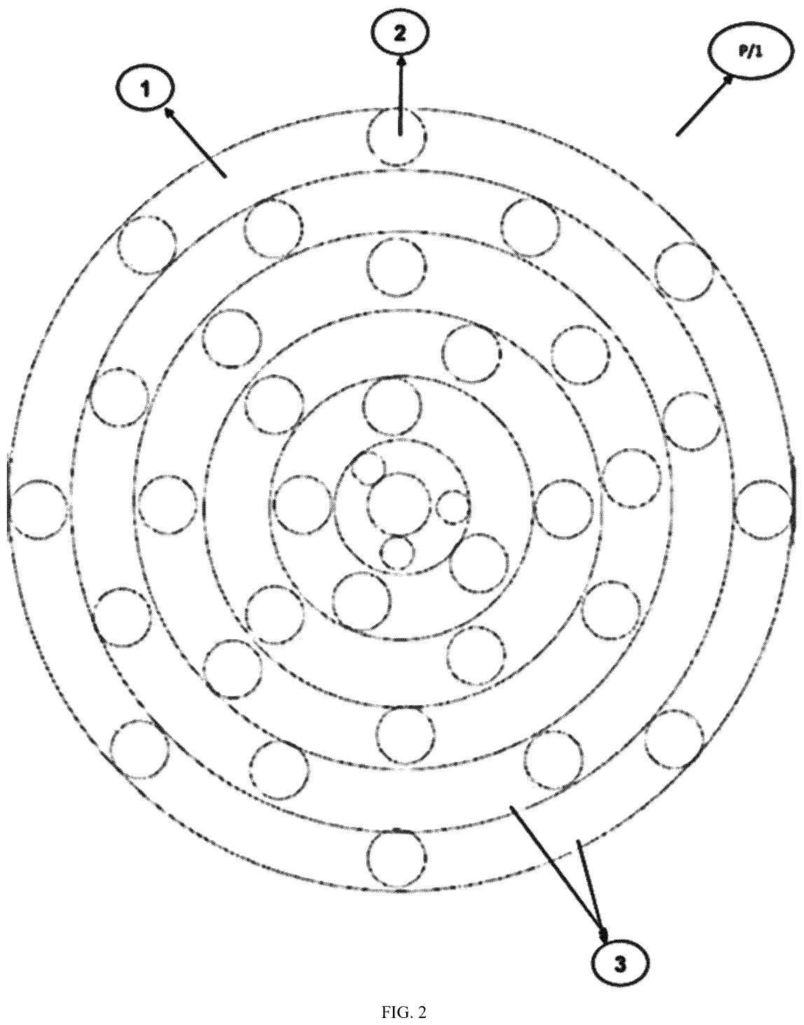

### DETAILED DESCRIPTION OF THE EMBODIMENTS

The parts in the figures are enumerated and described below.

| ELEMENT | | FUNCTION AND CHARACTERISTIC OF THE |
|---|---|---|
| NO | ELEMENT NAME | ELEMENT |
| 1 | Circle Wind Turbine | Allows the alternator motor to operate by transferring |
| | Nacelle | the rotational motion provided by the power of the wind |
| | | to the shaft |
| 2 | Turbine Blades | The main part collects the wind speed on its surface and |
| | | transfers it to the turbine. |
| 3 | Bottom and top apparatus | An apparatus that fixes the blades on the turbine and |
| | of the turbine | adjusts the operating position between the turbines. |
| 4 | Turbine Platform | A platform resembling a tree trunk made of all kinds of |
| | | materials on which turbines are installed. |
| P/1 | Pyramid Wind Turbine | An electricity generation system composed of wind |
| | | turbines of many different sizes and dimensions. |

### Description of the Invention

A monolithic pyramidal turbine, composed of turbines (1) of different sizes and dimensions shaped as a circle, which overlap in a vertical (vertical) structure and expand as they go down, and generate electricity from wind power that rotates either dependently or independently from each other on the horizontal (horizontal) axis to the ground. It is equipped with circular apparatus (3) that integrates turbines of different sizes, dimensions, and powers with each other. These apparatuses (3) function to fix and carry the blades (2) of the turbines, enable the turbines (1) to co-operate with each other and transfer the collected power to the engine. The structure composed of turbines with overlapping and gradually expanding scales is installed on the platform (4) located at the bottom. This platform (4) can be built either on a mast or on a roof or any ground.

### INDUSTRIAL APPLICATIONS OF THE INVENTION

The turbines manufactured from different materials in different sizes and dimensions are combined on a structure and the wind turbine, which resembles a pyramid that expands from top to bottom, serves as a device to generate electricity that is needed in all fields of industry and human life. The raw materials and components that are used during its production are easily available on the market. It allows all units that consume electricity to independently generate the renewable energy that they need.

What is claimed is:

1. A monolithic pyramidal turbine, wherein the monolithic pyramidal turbine resembles a pyramid and is composed of turbines of different sizes and different dimensions, the turbines are shaped as a circle, wherein the turbines overlap in a vertical structure placed on a turbine platform and expand as the vertical structure goes down, and the monolithic pyramidal turbine generates electricity from wind power, wherein each of the turbines rotates either dependently or independently from each other on a horizontal axis to ground, with top and bottom apparatuses, wherein the top and bottom apparatuses integrate the turbines of the different sizes, the different dimensions, and different powers with each other, function to fix and carry vertical blades of the turbines, wherein the turbines are allowed to co-operate with each other and transfer collected power to a motor.

2. The monolithic pyramidal turbine according to claim 1, wherein the monolithic pyramidal turbine comprises the turbines of the different sizes and the different dimensions, wherein the turbines are shaped as the circle, wherein the turbines are placed on the turbine platform in the vertical structure, the turbines are expand as the pyramid as the vertical structure goes down, and each of the turbines rotates either dependently or independently from each other on the horizontal axis to the ground.

3. The monolithic pyramidal turbine according to claim 1, wherein the top and bottom apparatuses comprise connections to integrate the turbines of the different sizes, the different dimensions, and the different powers, attachments to fix and carry the vertical blades of the turbines, and rods to allow the turbines to co-operate with each other and transfer the collected power to the motor.

4. The monolithic pyramidal turbine according to claim 1, wherein the turbine platform comprises a frame base and a mast, wherein the frame base connects the ground to the turbines, and the mast resembles a tree trunk.
